(19) United States
(12) Patent Application Publication
(10) Pub. No.: US 2012/0207972 A1
(43) Pub. Date: Aug. 16, 2012

(54) INSULATING FILM STRUCTURE AND MANUFACTURING METHOD THEREOF

(75) Inventors: Sunghyun Kim, Gyeonggi-do (KR); Dongjoo Shin, Gyeonggi-do (KR); Sungtaek Lim, Gyeonggi-do (KR); Choonkeun Lee, Gyeonggi-do (KR); Moonsoo Park, Gyeonggi-do (KR)

(73) Assignee: SAMSUNG ELECTRO-MECHANICS CO., LTD., Suwon (KR)

(21) Appl. No.: 13/351,871

(22) Filed: Jan. 17, 2012

(30) Foreign Application Priority Data
Feb. 14, 2011 (KR) 10-2011-0012777

(51) Int. Cl. B32B 27/08; B05D 5/12; B32B 3/00

(52) U.S. Cl. 428/141; 428/483; 428/516; 428/446; 427/58

(57) ABSTRACT

The present invention provides an insulating film structure with a simple configuration, which decreases a fraction defective to be generated when applied to various electronic materials, and a manufacturing method thereof, which includes a double-layered structure having an insulating film layer and a carrier film layer, wherein the carrier film layer includes a release layer formed on one side of the carrier film layer being in contact with the insulating film layer, and a surface-treated layer formed on the other side of the carrier film layer.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0012777, entitled filed Feb. 14, 2011, which is hereby incorporated by reference in its entirety into this application.

### BACKGROUND OF THE INVENTION

1. Field of the Invention

The present invention relates to an insulating film structure for protecting an insulating film which is used in various electronic materials, and a manufacturing method thereof.

2. Description of the Related Art

In recent years, with ever-increasing compact and multifunction in digital electronic products, the function of hi-tech product is on the rise. Especially, for a print circuit board (PCB), a buildup insulating film is used to implement a thickness reduction, a high integration and a microcircuit which are required for a high specification.

Such an insulating film may be made of two materials: one is a carrier film used for transfer in a casting process, and the other is a cover film used in protecting an insulating material after the casting process. The films employed as the two materials require different functions.

The carrier film includes a non-slip property to allow the insulating film to be smoothly transferred. In addition, the carrier film includes a release property to allow the carrier film to be smoothly released therefrom when applied to a product.

And, a protect film includes a lamination property to stably protect the insulating film. In addition, the protect film includes a release property to allow the protect film to be smoothly released therefrom when applied to a product.

As shown in FIG. 1, an insulating film structure according to the related art is manufactured in a roll shape, and includes a three-layered structure where an insulating film 2 is cast on a carrier film (PET) 1 which is not subject to a surface treatment, followed by a protect film 3 is form on the insulating film 2. The protect film 3 contains an adhesive for easy lamination.

When the roll-shaped insulating film structure with the configuration as described above is applied to a product, as shown in FIG. 2, a problem is posed in that the insulating film 2 is stripped while being separated the protect film 3 from the carrier film 1. The reason for this is that respective layers contained in the insulating film structure with the configuration as described above have no a given physicality.

This requires the development of a build-up insulating film which is matched to various electronic materials, including a printed circuit board.

### SUMMARY OF THE INVENTION

The present invention has been invented in order to overcome the above-described problems and it is, therefore, an object of the present invention to provide an insulating film structure with a simple configuration, which decreases a fraction defective to be generated when applied to various electronic materials.

Further, another object of the present invention is to provide a method of manufacturing an insulating film structure.

In accordance with one aspect of the present invention to achieve the object, there is provided an insulating film structure with a double-layered structure having an insulating film layer and a carrier film layer, wherein the carrier film layer including: a release layer formed on one side of the carrier film layer being in contact with the insulating film layer; and a surface-treated layer formed on the other side of the carrier film layer.

Preferably, a release force of the release layer formed on the carrier film layer is in the range of 30 gf to 1000 gf.

The surface of the surface-treated layer formed on the carrier film layer is subjected to a roughening process.

Preferably, a lamination force of the surface-treated layer formed on the carrier film layer is in the range of 34 dyne to 40 dyne.

Preferably, a surface resistance of the surface-treated layer formed on the surface-treated layer is in the range of 10¹⁰Ω to 10¹²Ω. The carrier film layer is formed by any one of PET (polyethylene terephthalate), PP (polypropylene) and PE (polyethylene).

Preferably, the insulating film is formed of one of B-stage resin and C-stage resin.

Further, in accordance with another aspect of the present invention to achieve the object, there is provided a method of manufacturing an insulating film structure, comprising: forming a release layer on one side of a carrier film layer; forming a surface-treated layer formed on the other side of the carrier film layer; and casting an insulating film on the carrier film layer with the release layer formed thereon.

Preferably, the release layer is formed by a silicon-based release process or a fluorine-based release process.

Preferably, the surface-treated layer is formed by one of a polyethylene resin made by using a metallocene catalytic agent and a film made by PP (polypropylene)/PE (polyethylene) block copolymer.

The method according to the present invention further comprises roughening the surface of the surface-treated layer.

Further, the roughening includes performing physical and chemical processes on the carrier film layer.

Accordingly, the present invention eliminates the need for a protect film layer, which has been additionally provided to protect an insulating film. Further, the insulating film structure according to the present invention is produced with a double-layered structure having an insulating film layer and a carrier film layer, thereby reducing purchase coat of materials required in producing the insulating film, and thereby lowering disposal cost of waste generated after production. Further, in a roll-shaped insulating film, it is possible to decrease a thickness of the insulating film by the order of thickness of the protect film layer, which further increases packing of the insulating film into a roll.

Furthermore, the insulating film structure with the configuration as described above can be used in protecting insulating films used in electronic materials. In addition, it is possible to avoid a problem that a carrier film layer is separated when applied to an actual product.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a sectional view of an insulating film structure according to the related art;

FIG. 2 is a sectional view showing a problem generated when an insulating film structure according to the related art is applied to an actual product;

FIG. 3 is a sectional view of an insulating film structure according to one illustrative embodiment of the present invention; and

FIG. 4 is a sectional view of an insulating film structure according to one illustrative embodiment of the present invention.

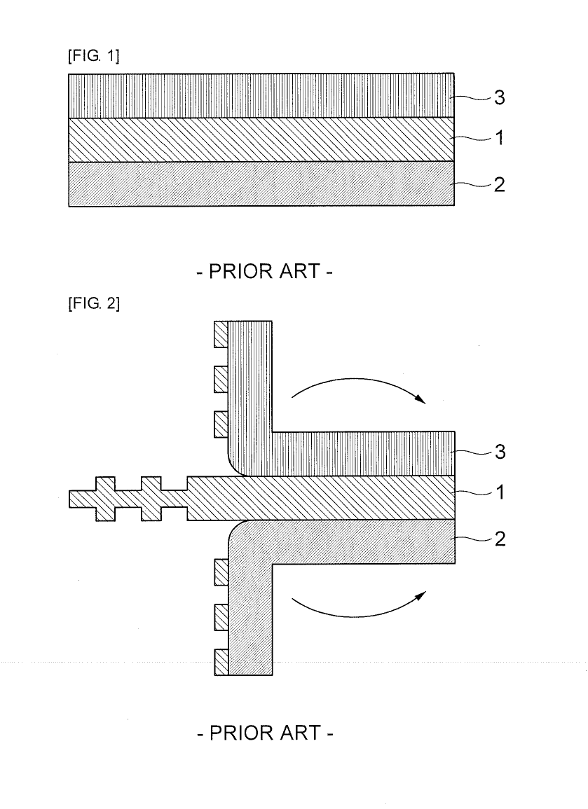

### DETAILED DESCRIPTION OF THE PREFERABLE EMBODIMENTS

Hereinafter, specific embodiments of the present invention will be described with reference to the accompanying drawings. However, the following embodiments are provided as examples but are not intended to limit the present invention thereto.

Descriptions of well-known components and processing techniques are omitted so as not to unnecessarily obscure the embodiments of the present invention. The following terms are defined in consideration of functions of the present invention and may be changed according to users or operator's intentions or customs. Thus, the terms shall be defined based on the contents described throughout the specification.

The technical sprit of the present invention should be defined by the appended claims, and the following embodiments are merely examples for efficiently describing the technical spirit of the present invention to those skilled in the art.

An insulating film structure according to the present invention eliminates the need for a protect film layer, which has been additionally provided to protect an insulating film. Further, the insulating film structure according to the present invention is produced with a double-layered structure having an insulating film layer and a carrier film layer. A release layer is formed on one side of the carrier film layer being in contact with the insulating film layer, and a surface-treated layer is formed on the other side of the carrier film layer. Thus, the insulating film structure according to the present invention functions as both the carrier film layer and the protect film layer.

In the insulating film structure according to the present invention, the carrier film layer includes a non-slip property to allow the insulating film formed on the carrier film layer to be smoothly transferred. Further, the carrier film layer includes a release property to allow the carrier film layer to be smoothly separated when applied to a product. To support this, a release layer is formed on a surface on which the insulating film is cast.

Preferably, the release layer is formed by a silicon-based release process or a fluorine-based release process, but not limited thereto.

A release force of the release layer formed on the carrier film layer is preferably in the range of 30 gf to 1000 gf. When the release force of the release layer is larger than 1000 gf, the carrier film may not be smoothly removed after the insulating film is applied during substrate production processes, which results in surface defects of the insulating film. Meanwhile, when the release force of the release layer is less than 30 gf, the insulating film may be transferred to the opposite side of the release layer formed on the carrier film layer, when applied to the insulating film.

Subsequently, in order to obtain a characteristic of the protect film layer to be laminated on the insulating film, a surface treatment is performed on the opposite side of the carrier film layer on which the insulating film is cast.

The surface treatment is performed by one of a polyolefin resin made by using a metallocene catalytic agent, and PP (polypropylene)/PE (polyethylene) block copolymer, but not limited thereto.

In this case, a lamination force of the surface-treated layer formed on the carrier film layer is set to be in the range of 34 dyne to 40 dyne. Setting the lamination force of the surface-treated layer to be less than 34 dyne causes a non-uniform lamination between the insulating film and the protect film layer. Meanwhile, setting the lamination force of the surface-treated layer to be more than 34 dyne causes that the insulating film is transferred to the protect film layer when the protect film layer is removed during a substrate production process.

Further, a surface resistance of the surface-treated layer formed on the carrier film layer is preferably set to be the range of 10¹⁰Ω to 10¹²Ω. For the surface resistance of 10¹⁰Ω, to 10¹²Ω, antistatic effect is manifested on the surface of the surface-treated layer. This prevents dust in the air from being attached to the insulating film by a static electricity generated while removing the protect film layer.

Therefore, the carrier film layer according to the present invention develops two different properties on both the protect film layer and the carrier film layer.

Further, a roughening process is performed on the surface-treated layer so that an indirect process efficiency for a roll-shaped product is further increased when applied to the product, which minimizes contact area between surfaces to be laminated. This facilitates discharge of the insulating film wound in a roll. The roughening process includes performing physical and chemical processes on the carrier film layer. Accordingly, a fine roughness may be achieved.

In the insulating film structure according to the present invention, the carrier film layer may be formed by any one of PET, PP and PE, and may be preferably formed by PET, but not limited thereto.

In the insulating film structure according to the present invention, the insulating film may be made of B-stage resin or C-stage resin, but not limited thereto.

In the following, a description will be made as to the manufacturing method of the insulating film structure according to the present invention.

The manufacturing method of the insulating film structure according to the present invention includes forming a release layer on one side of a carrier film layer, forming a surface-treated layer formed on the other side of the carrier film layer, and casting an insulating film on the carrier film layer with the release layer formed thereon.

The release layer formed on the one side of the carrier film layer is formed by a silicon-based release process or a fluorine-based release process.

A silicon coating is a process which coats a silicon resin as an organic silicon compound on the surface of the carrier film layer. Herein, the silicon resin has been described to be used, but not limited thereto. For example, various types of silicon resins may be used in treating the surface of the carrier film layer.

The fluorine-based release process is a process which coats a fluorine resin on the surface of the carrier film layer in place of the silicon resin. Herein, the fluorine resin has been described to be used, but not limited thereto. For example, various types of silicon resins which are capable of providing a release property, may be used.

Preferably, a thickness of the release layer is set to be in the range of 0.3 to 0.4 micrometers to obtain a release force ranging from 30 gf to 1000 gf.

Subsequently, the surface-treated layer is formed on the opposite side of the carrier film layer with the release layer formed thereon. The surface-treated layer may be formed by one of a polyolefin resin made by using a metallocene catalytic agent, or PP (polypropylene)/PE (polyethylene) block copolymer.

Further, the insulating film structure manufacturing method according to the present invention may further include roughening the surface of the surface-treated layer.

The roughening process includes performing physical and chemical processes on the carrier film layer. This achieves a fine roughness. The roughening on the surface-treated layer minimizes contact area between surfaces to be laminated. This facilitates discharge of the insulating film wound in a roll.

FIG. 3 is a sectional view showing an insulating film structure according to one illustrative embodiment of the present invention.

As shown in FIG. 3, an insulating film structure 100 according to one illustrative embodiment includes a double-layered structure having an insulating film layer 10 and a carrier film layer 20.

First, a release layer 21 is formed by coating silicon or fluorine resin on one side of the carrier film layer 20 which is in contact with the insulating film layer 10. As one example, the carrier film may be formed by polyethylene terephthalate (PET).

Further, a surface-treated layer 22 is formed by coating a polyolefin resin made by using a metallocene catalytic agent, or a film made by PP (polypropylene)/PE (polyethylene) block copolymer, on the other side of the carrier film layer 20.

Accordingly, the carrier film layer 20 according to the present invention includes the release layer 21 and the surface-treated layer 22, which functions as both of the carrier film layer and the protect film layer.

A release force of the release layer 21 formed on the carrier film layer 20 is in the range of 30 gf to 1000 gf.

A lamination force of the surface-treated layer 22 formed on the carrier film layer 20 is in the range of 34 dyne to 40 dyne. Further, a surface resistance of the surface-treated layer 22 is in the range of 10¹⁰Ω to 10¹²Ω.

Subsequently, the insulating film layer 10 is formed by casting an epoxy resin on the carrier film layer 20 with the release layer 21 formed thereon. Preferably, the carrier film layer 20 may be formed by an epoxy resin. Further, the carrier film layer 20 may be formed at B-stage (i.e., a partially-cured state) or C-stage (i.e, a completely-cured state).

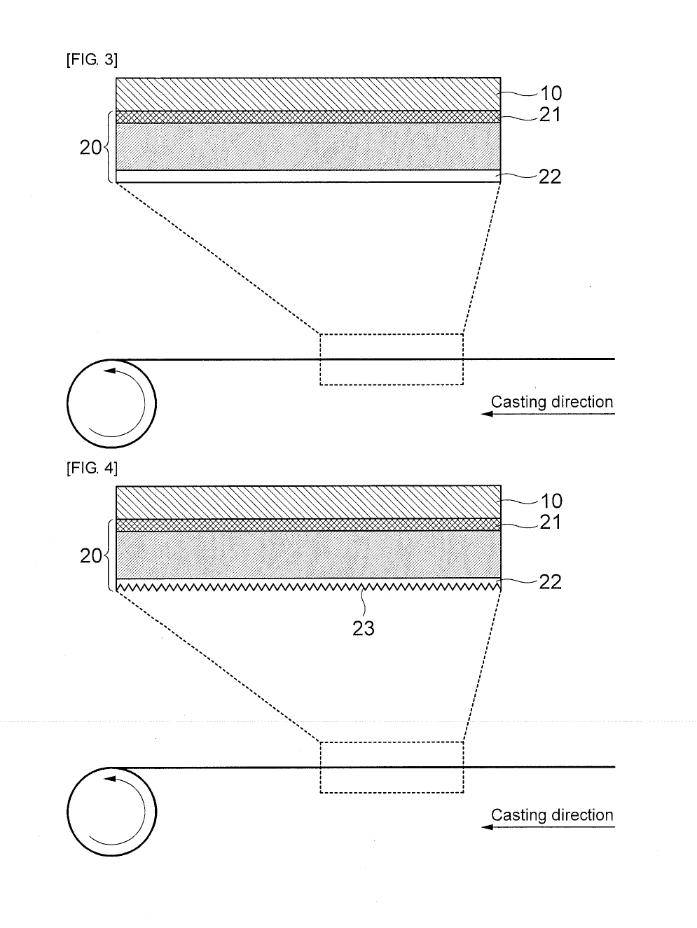

Further, the insulating film structure manufacturing method according to the present invention may further include roughening the surface of the surface-treated layer 22. As a result, as shown in FIG. 4, the roughening allows the surface-treated layer 22 to have a constant roughness 23. With this arrangement, using the insulating film structure wound in a roll facilitates discharge of the insulating film.

While the invention has been described in detail with reference to preferred embodiments thereof, it will be appreciated by those skilled in the art that changes may be made in these embodiments without departing from the scope of the invention.

Thus, the scope of the invention should be determined by the appended claims and their equivalents, rather than by the described embodiments.

What is claimed is:

1. An insulating film structure with a double-layered structure having an insulating film layer and a carrier film layer,
wherein the carrier film layer includes:
a release layer formed on one side of the carrier film layer being in contact with the insulating film layer; and
a surface-treated layer formed on the other side of the carrier film layer.

2. The insulating film structure according to claim 1, wherein a release force of the release layer formed on the carrier film layer is in the range of 30 gf to 1000 gf.

3. The insulating film structure according to claim 1, wherein the surface of the surface-treated layer formed on the carrier film layer is subjected to a roughening process.

4. The insulating film structure according to claim 1, wherein a lamination force of the surface-treated layer formed on the carrier film layer is in the range of 34 dyne to 40 dyne.

5. The insulating film structure according to claim 1, wherein a surface resistance of the surface-treated layer is in the range of 10¹⁰Ω to 10¹²Ω.

6. The insulating film structure according to claim 1, wherein the carrier film layer is formed by any one of PET, PP and PE.

7. The insulating film structure according to claim 1, wherein the insulating film is formed of one of B-stage resin and C-stage resin.

8. A method of manufacturing an insulating film structure, comprising:
forming a release layer on one side of a carrier film layer;
forming a surface-treated layer formed on the other side of the carrier film layer; and
casting an insulating film on the carrier film layer with the release layer formed thereon.

9. The method according to claim 8, wherein the release layer is formed by a silicon-based release process or a fluorine-based release process.

10. The method according to claim 8, wherein the surface-treated layer is formed of one of a polyethylene resin made by using a metallocene catalytic agent and PP (polypropylene)/PE (polyethylene) block copolymer.

11. The method according to claim 8, further comprising roughening the surface of the surface-treated layer.

12. The method according to claim 11, wherein the roughening includes performing physical and chemical processes on the carrier film layer.
